(19) United States
(12) Patent Application Publication
(10) Pub. No.: US 2009/0003218 A1
(43) Pub. Date: Jan. 1, 2009

(54) WIRELESS COMMUNICATION SYSTEM PERFORMANCE UPDATES USING AUTOMATED DATABASE MANAGEMENT

(76) Inventor: Wen-Pin Lin, Morristown, NJ (US)

Correspondence Address: CARLSON, GASKEY & OLDS, P.C./Alcatel-Lucent, 400 W MAPLE RD, SUITE 350, BIRMINGHAM, MI, 48009, US

(21) Appl. No.: 11/769,759

(22) Filed: Jun. 28, 2007

(51) Int. Cl. H04L 12/26

(52) U.S. Cl. 370/241

(57) ABSTRACT

A disclosed method of managing a wireless communication database that is used to control at least a selected portion of a wireless communication system includes determining when a service measurement indicates a desired change in the wireless communication system performance. Any new parameters for implementing the desired change are automatically determined. Any corresponding changes to the database are then automatically made.

### FIELD OF THE INVENTION

This invention generally relates to communication. More particularly, this invention relates to wireless communications.

### DESCRIPTION OF THE RELATED ART

Wireless communication systems are well known and in widespread use. Typical arrangements include a variety of network components and equipment for facilitating wireless communications on behalf of mobile subscribers. Typical arrangements include a plurality of base station transceivers geographically positioned to provide wireless communication coverage in desired areas. Control equipment such as a radio network controller facilitates communication between the base station transceivers and a wireless network that includes a plurality of known components.

Typical wireless communication arrangements include a database that is used for controlling and facilitating operation of a variety of the system components. Changes to system operation that may enhance the performance of the system often are implemented by changes to the database of network parameters. One difficulty with conventional systems is that manual changes to the database are required to update or change any parameters for attempting to realize improved or different performance. The manual implementation of such challenges is time consuming and very challenging.

Wireless communication databases are typically very complex. Consider, for example, a communication system that includes an executive cellular processor that is associated with 300 cells, each having three carriers with three sectors per carrier. Each such executive cellular processor will typically have more than 1500 fields of data within the database that need to be populated and updated to provide desired system performance. A service provider that has 200 operating executive cellular processors must maintain more than 30,000 data fields to ensure proper operation and to provide a desired level of wireless service.

In addition to the challenges presented by the large volume of data, a wireless communication database typically is arranged into forms that have various pages with each page having various fields. One challenge associated with using such a database is presented to a technician who has to locate particular data fields for updating the data, for example. Not only must the technician be able to find the appropriate form, page and field, but they must also be able to ensure that any changes made to them will not adversely affect system operation.

These issues all introduce additional time and expense in maintaining and updating a wireless communication system. The associated time required for updating the system interferes with a service provider's ability to achieve a desired level of system performance. In many instances, the time it takes to make such an update is longer than the period within which the update would have been useful because the situation for which the update would have been useful has changed, for example.

There is a need for a technique to facilitate wireless communication database management that would facilitate updating parameters to realize performance enhancements without the drawbacks described above.

### SUMMARY

An exemplary method of managing a wireless communication database that is used to control at least a selected portion of a wireless communication system includes determining when a service measurement indicates a desired change in performance of at least a portion of the system. Any updates to the database for implementing the desired change are automatically determined. Any corresponding updates to the database are then automatically implemented.

The example method allows for automatically and rapidly updating a wireless communication system's performance. One example includes providing an indication of any automatically implemented change to an individual so that any such changes and their effects can be determined or any other changes that need to be made can be determined.

One example implementation includes a computer readable medium containing a plurality of computer-executable instructions for managing a wireless communication database that is used to control at least a selected portion of a wireless communication system. The instructions include instructions for automatically determining when a service measurement indicates a desired change in performance of at least a portion of the system. Other instructions are for automatically determining any updates to the database for implementing the desired change. Other instructions are for automatically implementing any such updates to the database.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically shows selected portions of a wireless communication system that is useful with an embodiment of this invention.

FIG. 2 schematically in a flow chart diagram summarizing an example procedure used with an embodiment of this invention.

### DETAILED DESCRIPTION

This invention provides a technique for managing a database such as a wireless communication database. An example embodiment is described below that automatically implements updates to the database when a service measurement indicates that such an update will be useful for realizing a desired change in performance indicated by the service measurement.

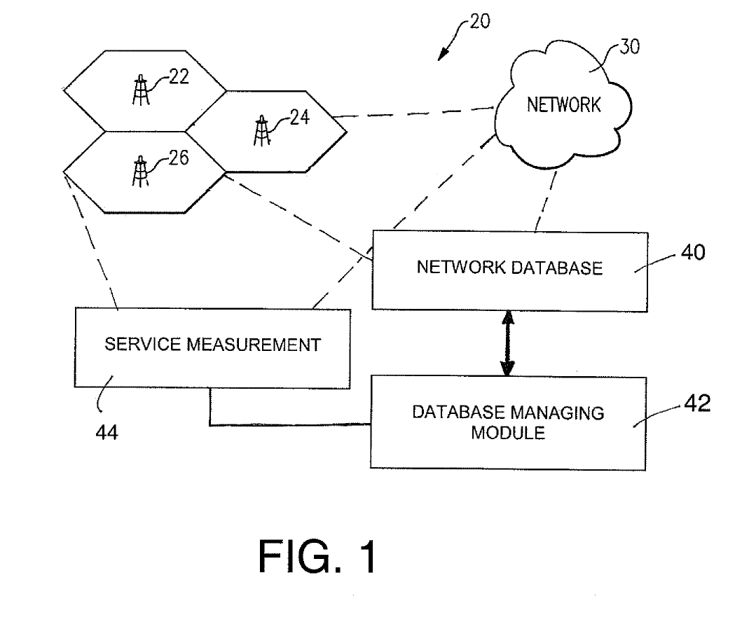

FIG. 1 schematically shows selected portions of a wireless communication system 20. Base station transceivers 22, 24 and 26 provide wireless communication coverage over geographic regions commonly referred to as cells. Each cell is divided into sectors in a known manner. A plurality of other communication system components operate as a network 30 in a generally known manner. As known, there are a variety of components and different kinds of equipment involved in the various portions of the wireless communication system 20.

The illustrated example includes a wireless communication database 40 that includes a plurality of types of data, parameters and information that is used for operating the wireless communication system 20. A database managing module 42 is associated with the database 40 for automatically making changes to the contents of the database 40 for realizing a desired change in the performance of at least a portion of the system 20.

The database management module 42 in one example comprises software programmed into a controller or computer associated with the system 20. One advantage to one example implementation is that it does not require new or additional hardware in the system but rather only requires new software and suitable programming. Given this description, those skilled in the art will realize how to program an appropriate device or to develop software to realize the functions of the example database management module 42.

A service measurement portion 44 provides service measurement information regarding ongoing performance of one or more portions of the system 20. There are known techniques for monitoring various operating parameters of a wireless communication system. The service measurement portion 44 in one example uses such known techniques. The database managing module 42 utilizes information from the service measurement portion 44 for automatically determining whether the service measurement information indicates that a change is desired in the performance of any portion of the system 20. If so, the database management module 42 automatically determines whether there are any parameters within the database 40 that should be updated to realize the desired change in performance. If so, the database management module 42 automatically implements the corresponding update or updates to the database 40.

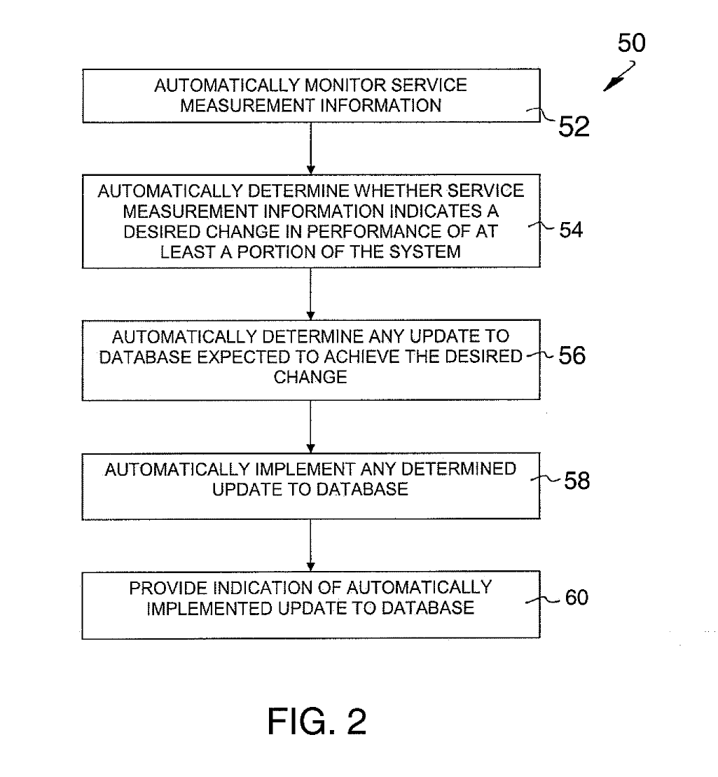

FIG. 2 includes a flow chart diagram 50 that summarizes one example approach. At 52, the database management module 42 automatically monitors the service measurement information. Example types of service measurement information include signal strengths, call drop rates, mobile search window parameters, frame error rates and hand off range and criterion. Given this description, those skilled in the art will realize what type of service information will be useful for their particular situation.

At 54 the database management module 42 automatically determines whether the service measurement information indicates that a change is desired in the performance of at least a portion of the system 20. One example includes establishing a plurality of criteria that are provided to the database management module 42 so that the database management module 42 is able to determine whether any of the criteria are met in a way that indicates a change should be made. Such changes may alter the performance of the system to provide enhanced service to mobile subscribers, for example.

At 54, the database management module 42 automatically determines whether there are any updates to the database 40 that will be likely to bring about the desired change. In one example, the database management module 42 is provided with a plurality of algorithms for making such a determination.

For example, assume that mobile stations are reporting a frame error rate to the base station 22. The pre-established criteria will indicate when the frame error rate information indicates poor performance or some other factor that warrants a change in performance. The algorithm used by the database management module 42 in one such example indicates that when the frame error rate percentage is within a first range, the associated signal strengths used for transmissions from the base station is updated to a first value. If the frame error rate percentage is within a second range, then the corresponding database parameter is updated to a second value.

In another example, the database management module 42 determines when a dropped call rate is too high for a particular sector that is near a coastline. In this example, mobile stations out at sea may be able to detect weak signals from the sector and the subscriber may attempt to place a call using the mobile station. Because the signal may be very weak further from shore, the mobile station may report a dropped call if it is unable to make the connection for placing the call. The algorithm used by the database management module 42 in one such example determines whether the sector is in a location where this scenario may occur. If so, the database management module 42 follows the logic of the algorithm to determine whether any updates in a parameter of the database 40 such as a search window parameter used by the mobiles should be updated. For example, by increasing the length of the search window used by such mobile stations, it is possible to increase the likelihood of establishing a successful connection to place the call. The database management module 42 makes such a determination based upon the corresponding information from the service measurement portion 44 and the algorithm related to the corresponding pre-established criteria.

In another example, the database management module 42 determines that performance of data traffic decreases at certain times of day. The database management module 42 uses the analysis criteria and decision algorithm to determine whether any updates to database parameters are in order. In one such example, the database management module 42 determines that an update to a bandwidth allocation strategy and the way in which priorities are set for such users will likely provide improved performance.

In one example, the database management module 42 determines a current value of the parameter in the database 40 that corresponds to the parameter that the database management module 42 has determined might be updated. If the current corresponding parameter value is different than the value indicated by the algorithm, the database management module 42 automatically determines that an update to that parameter is needed. This determination is shown at 56 in the example of FIG. 2.

At 58, when appropriate, the database management module 42 automatically updates the corresponding parameter in the database 40. Of course, if there is no update needed, the database management module 42 continues with the monitoring at 52.

At 60, the database management module 42 provides an indication of the automatically implemented update to the database 40. A time stamp is associated with the update in this example. The indication in one example is provided to an individual or personnel who can analyze the update. In one example, the indication includes information regarding the desired change that the updated value or parameter is supposed to cause. One example includes providing an indication of the service measurement information that is the basis of the decision regarding the desired change. Some examples include an indication of the decision criteria and the algorithm used for making all related decisions within the database management module 42.

In some examples, the indicated information allows an individual to take responsive action. One example includes providing the individual an ability to reject the update and the previous value will be restored for the corresponding parameter in the database 40. An individual in one example has the ability to override the update to a different value from the previous or automatically implemented value. One example allows the individual to confirm that the automatically updated value should be kept. Otherwise, in the latter example, the previous value will automatically be restored after expiration of an appropriate time.

One example provides the ability to track changes implemented by the database management module 42 to determine whether they are having the desired effects and accomplishing results consistent with the desired changes that prompted the automatically implemented changes. This example allows a network provider or operator to adjust the decision criteria or algorithms used by the database management module 42 if necessary or to determine whether a pattern of changes has developed that is useful. If so, the network provider or operator may implement other changes to how the system 20 operates on some regular basis so that the database management module 42 need not repeatedly continue to make the same or very similar changes over and over again.

One feature of the disclosed example is that the database management module 42 is capable of monitoring the system 20 and implementing changes much faster than was possible with conventional arrangements that relied upon manual analysis and change implementation. In one example, the database management module 42 performs the steps outlined in FIG. 2 at least once each day. In another example, the database management module 42 performs those steps at least once each hour. Hourly or daily analysis and updates are a significant improvement over what has been possible before and allows for the database 40 to be updated in a manner that is responsive to what can be rapidly changing conditions affecting performance of a portion of the system 20.

Another feature of the disclosed examples is that they avoid human errors in updating the wrong parameters in the database 40 or updating with improper values by mistake. When information is reported regarding the automatically implemented updates and that information is analyzed appropriately, further performance improvements can be realized by adjusting the performance of the database management module 42 accordingly.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A method of managing a wireless communication database that is used to control at least a portion of a wireless communication system, comprising:
automatically determining whether a service measurement indicates a desired change in a performance of at least one portion of the wireless communication system;
automatically determining whether any updates to any parameters in the database are expected to make the desired change; and
automatically implementing the determined any updates to the database.

2. The method of claim 1, comprising
providing an indication of any automatically implemented update for review by an individual.

3. The method of claim 2, comprising
allowing the individual to do at least one of
reject the automatically implemented update;
override the automatically implemented update; or
confirm the automatically implemented update.

4. The method of claim 2, comprising
providing an indication of the desired change associated with the automatically implemented update.

5. The method of claim 4, comprising
providing an indication of the service measurement associated with the automatically implemented update.

6. The method of claim 2, comprising
subsequently providing a performance report indicating any effect of the automatically implemented update.

7. The method of claim 1, comprising
performing the determining steps and the implementing step at least once a day.

8. The method of claim 1, comprising
performing the determining steps and the implementing step at least once an hour.

9. The method of claim 1, comprising
performing the determining steps and the implementing step for at least one of:
a selected piece of equipment of the wireless communication network;
a selected plurality of pieces of equipment of the wireless communication network;
a selected cell of the wireless communication network;
a plurality of cells of the wireless communication network; or
a selected sector of the wireless communication network.
automatically applying the proposed change to the at least one portion, or
automatically providing an indication of the at least one portion.

10. The method of claim 1, comprising
establishing a plurality of criteria that correspond to at least one desired change; and
automatically determining when a service measurement satisfies at least one of the criteria.

11. A computer readable medium containing computer-executable instructions useful for managing a wireless communication database that is used to control at least a portion of a wireless communication system, comprising:
instructions for automatically determining whether a service measurement indicates a desired change in a performance of at least one portion of the wireless communication system;
instructions for automatically determining whether any updates to any parameters in the database are expected to make the desired change; and
instructions for automatically implementing the determined any updates to the database.

12. The computer readable medium of claim 11, comprising
instructions for providing an indication of any automatically implemented update for review by an individual.

13. The computer readable medium of claim 12, comprising
instructions for allowing the individual to do at least one of
reject the automatically implemented update;
override the automatically implemented update; or
confirm the automatically implemented update.

14. The computer readable medium of claim 12, comprising
instructions for providing an indication of the desired change associated with the automatically implemented update.

15. The computer readable medium of claim 14, comprising
instructions for providing an indication of the service measurement associated with the automatically implemented update.

16. The computer readable medium of claim 12, comprising
instructions for subsequently providing a performance report indicating any effect of the automatically implemented update.

17. The computer readable medium of claim 11, comprising
instructions for performing the determining steps and the implementing step at least once a day.

18. The computer readable medium of claim 11, comprising
instructions for performing the determining steps and the implementing step at least once an hour.
instructions for tracking an identity of a user requesting the proposed change and a time at which the proposed change is implemented.

19. The computer readable medium of claim 11, wherein the instructions for performing the determining steps and the implementing step are configured for controlling at least one of:
a selected piece of equipment of the wireless communication network;
a selected plurality of pieces of equipment of the wireless communication network;
a selected cell of the wireless communication network;
a plurality of cells of the wireless communication network; or
a selected sector of the wireless communication network.

20. The computer readable medium of claim 11, comprising
instructions for establishing a plurality of criteria that correspond to at least one desired change; and
instructions for automatically determining when a service measurement satisfies at least one of the criteria.
